(19) United States
(12) Patent Application Publication
(10) Pub. No.: US 2008/0068850 A1
(43) Pub. Date: Mar. 20, 2008

(54) SLIDING VANITY DOOR WITH INTEGRAL LENS

(75) Inventors: John M. Tiesler, Harrison Township, MI (US); James R. Mestemaker, Lambertville, MI (US); Michael C. Dykman, Lake Orion, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/531,896

(22) Filed: Sep. 14, 2006

(51) Int. Cl. B60Q 3/02

(52) U.S. Cl. 362/492; 362/137

(57) ABSTRACT

A sun visor includes a vanity assembly attached to a sun visor blade assembly. The vanity assembly includes a mirror subassembly, a light subassembly, and a door subassembly. The door subassembly is reversibly movable from an open to a closed position relative to mirror subassembly and light subassembly such that an illumination source within the light subassembly is actuated when the door subassembly is in the open position.

### BACKGROUND OF THE INVENTION

1. Field of the Invention

The present invention is related to sun visors for automobile interiors with integral illuminated vanities, and in particular, to sun visors for automobile interiors with integral illuminated vanities that automatically illuminate when opened.

2. Background Art

The use of sun visors in automobile applications is well known. A typical sun visor is attached to a passenger compartment roof adjacent to the windshield. Sun visors are made in various sizes and are made from a variety of materials. Sun visors are usually mounted on a bent arm shaft that is attached to the roof header on both the driver and front occupant sides of the vehicle.

The typical vehicle sun visor has a sun visor body or blade and a sun visor bent shaft. In some prior art sun visors, a mirror which is usually known as a vanity mirror is included. Such vanity mirrors are usually superimposed on the sun visor or integrated in the sun visor structure. Integrated vanity mirrors typically include a boxlike shell and a cover plate. The boxlike shell is usually prismatic in shape. Moreover, this boxlike shell design is opened on the front surface when viewing the mirror is desired. The boxlike shell is configured to contain the mirrored surface as well as other devices related with the functionality of the vanity mirror. Examples of such devices include a light for illumination while an occupant is looking into the mirror. The vanity mirror cover plate is attached to the boxlike shell, and may be operated at will by the user so that the latter may conceal the mirrored surface or open it to view. Although these prior art vanity mirror designs work reasonably well, there are a number of important considerations. For example, the prior art designs tend to be expensive and bulky.

Accordingly, for at least these reasons, there is a need in the prior art for improved sun visor designs with integrated vanity mirrors.

### SUMMARY OF THE INVENTION

The present invention solves one or more problems of the prior art by providing in at least one embodiment a sun visor having an integral illuminated vanity. The sun visor of the present embodiment is useable in automotive applications. Specifically, the sun visor may be mounted adjacent on either the driver or front occupants side of a vehicle passenger compartment, as well as, any other convenient location in a vehicle interior. The sun visor of this embodiment includes a vanity assembly attached to a sun visor blade assembly. The vanity assembly includes a mirror subassembly, a light subassembly, and a door subassembly. The door subassembly is reversibly movable from an open to a closed position relative to mirror subassembly and light subassembly. Advantageously, an illumination source within the light subassembly is actuated when the door subassembly is in the open position.

### BRIEF DESCRIPTION OF THE DRAWINGS

FIG. 1 is a perspective view of an embodiment of a sun visor encompassed by the present invention;

FIG. 2 is an exploded view of the sun visor described by FIG. 1;

FIG. 3 is a top view of a visor blade assembly in an open configuration;

FIG. 4A is a cross-section of a sun visor taken through an illumination source with a moveable door in the open position;

FIG. 4B is a cross-section of a sun visor taken through an illumination source with a moveable door in the closed position;

FIG. 5 is a cross-section of a sun visor taken through a light subassembly with a moveable door in a nearly closed position;

FIG. 6 is a cross-section of a sun visor taken through a light subassembly but orthogonal to the sections of FIGS. 4A and 4B with a moveable door in a nearly closed position;

FIG. 7 is a perspective view of a vanity retainer used to attach the vanity assembly to the sun blade assembly;

FIG. 8A is a cross-section of a sun visor that uses a vanity bezel at an edge of a vanity retainer;

FIG. 8B is a cross-section of a sun visor with a similar configuration to FIG. 8B but also having an edge wrap opening construction; and

FIG. 8C is a cross-section of a sun visor configuration that uses an edge wrap opening construction but not a vanity bezel.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

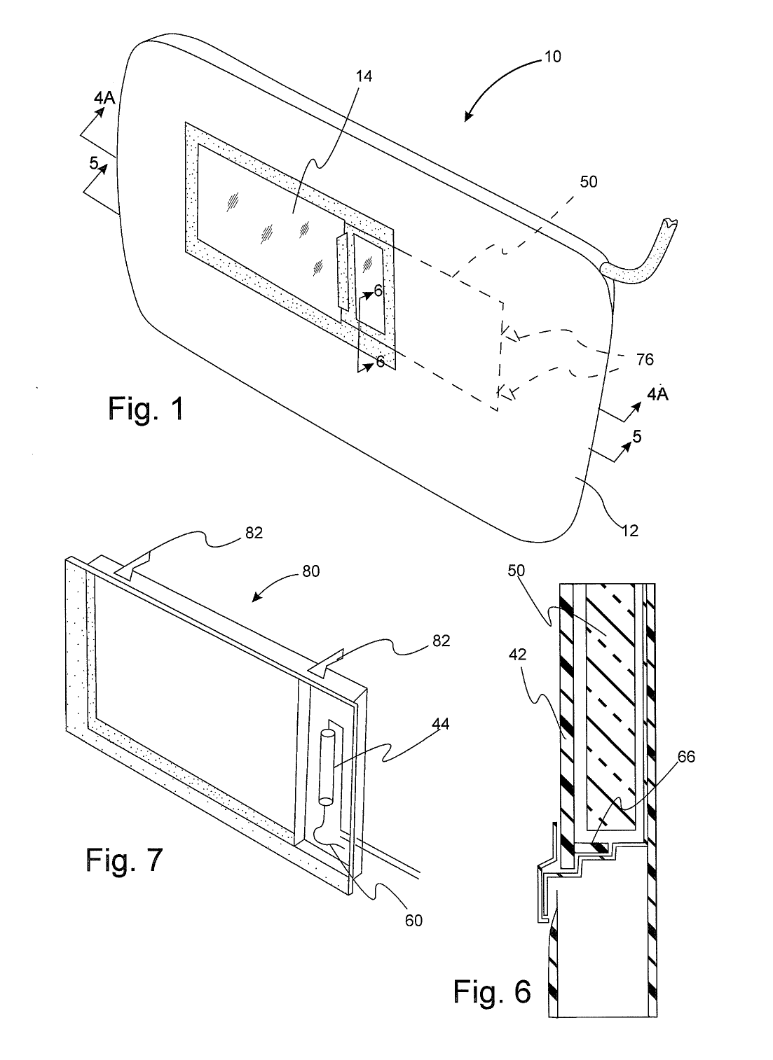

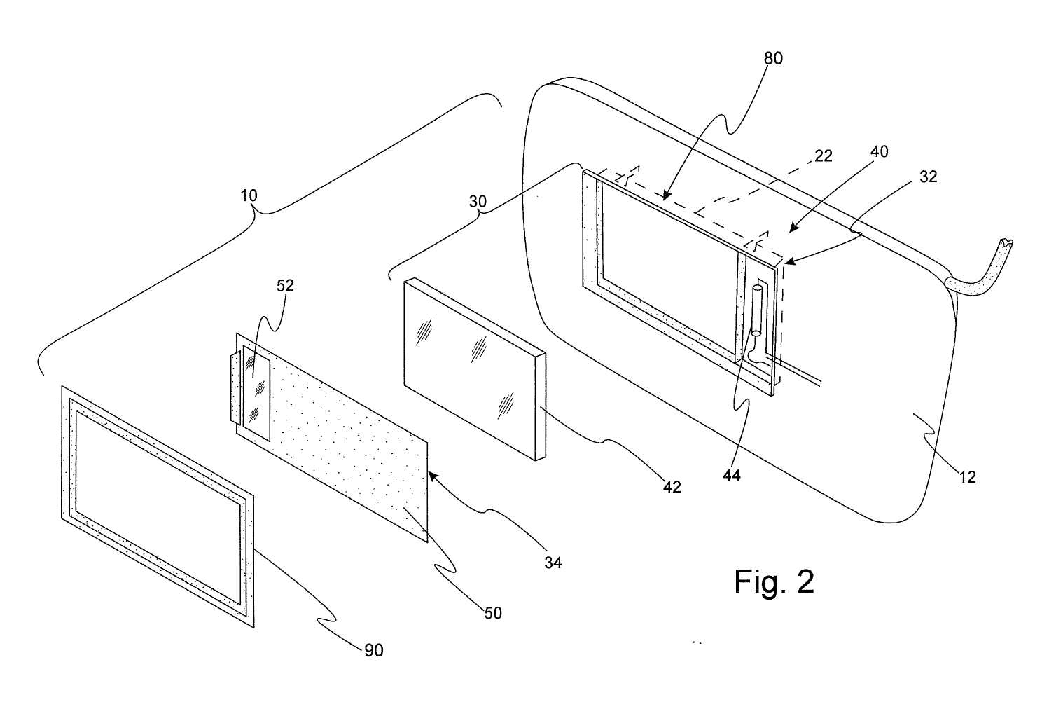

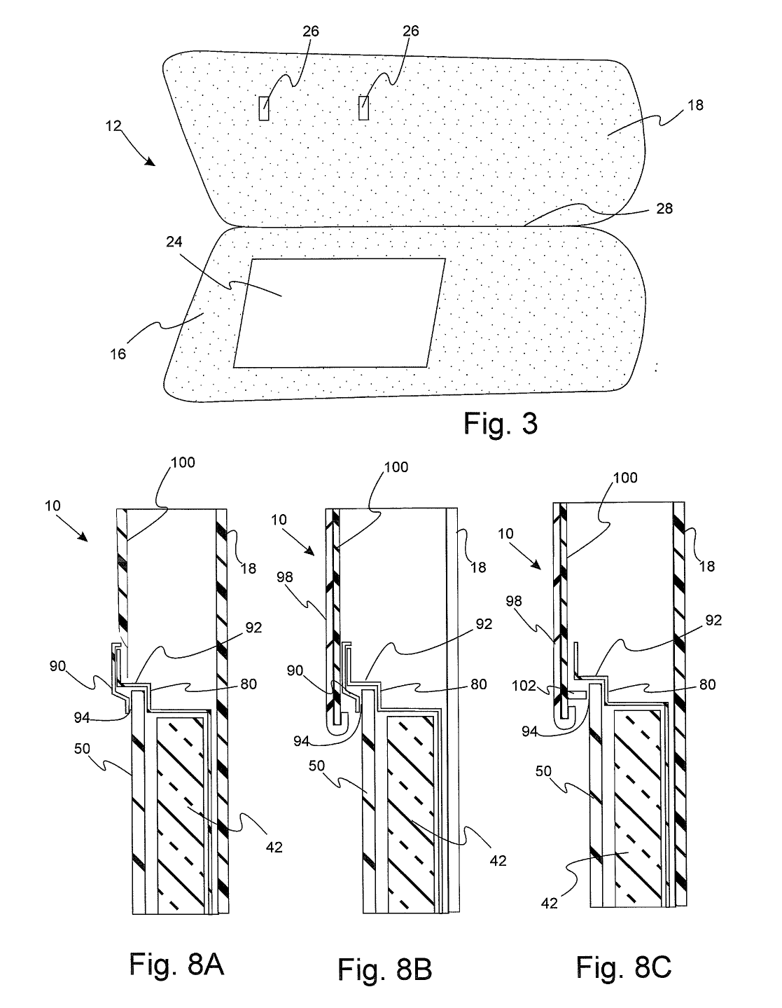

With reference to FIGS. 1, 2 and 3, schematic illustrations of an embodiment of the sun visor of the present invention are provided. FIG. 1 is a perspective view of the sun visor of this embodiment. FIG. 2 is an exploded view of the sun visor of this embodiment. Sun visor 10 includes visor blade assembly 12 and vanity assembly 14. FIG. 3 is a top view of visor blade assembly 12 in an open configuration. Visor blade assembly 12 includes first blade section 16 and second blade section 18 which are attached together to form vanity receptacle 22. To this end first blade section 16 includes opening 24, and second blade section 18 include snap receivers 26. In a variation of the present invention, first blade section 16 and second blade section 18 are attached together alone hinge section 28. Vanity assembly 14 is positioned within and/or attached to vanity receptacle 22.

Still referring to FIGS. 1 and 2, vanity assembly 14 includes mirror subassembly 30, light subassembly 32 and door subassembly 34. Door subassembly 34 is reversibly movable from an open to a closed position relative to mirror subassembly 30 and light subassembly 32. Typically, in order to accommodate this movement, mirror subassembly 30 and light subassembly 32 are adjacent to each other. In one variation, mirror subassembly 30 and light subassembly 32 are directly attached to form mirror-light subassembly 40. Mirror subassembly 30 includes at least one mirror 42. Light subassembly 32 includes at least one illumination source 44. Door subassembly 34 includes movable door 50 and light-transmitting component 52 attached to movable door 50. Examples of light sources that may be used for illumination source 44 include, but are not limited to, incandescent light bulbs, light emitting diodes, electroluminescent devices, fluorescent lights, and the like. When door subassembly 34 is positioned in the open position, light transmitting component 52 aligns with illumination source 44 such that light emanating from illumination source 44 is transmitted out of light subassembly 32 thereby allowing a person looking into at least one mirror 42 to be illuminated.

Light transmitting component 52 includes virtually any structure or material capable of transmitting visible light. Such structures include glass or plastic windows, one or more lenses and combinations thereof. Utilization of a lens is particularly useful by allowing focusing or collimation of light emanating from illumination source 44. Typical materials from which light transmitting component 52 is made from includes, but are not limited to, polycarbonate, acrylic, glass, and combinations thereof. In some variations, light transmitting component 52 is a convex or concave lens depending upon the visual effect desired. In a further refinement, light-transmitting component 52 comprises a Fresnel lens. In some additional variations, light-transmitting component 52 comprises at least one substantially planer surface.

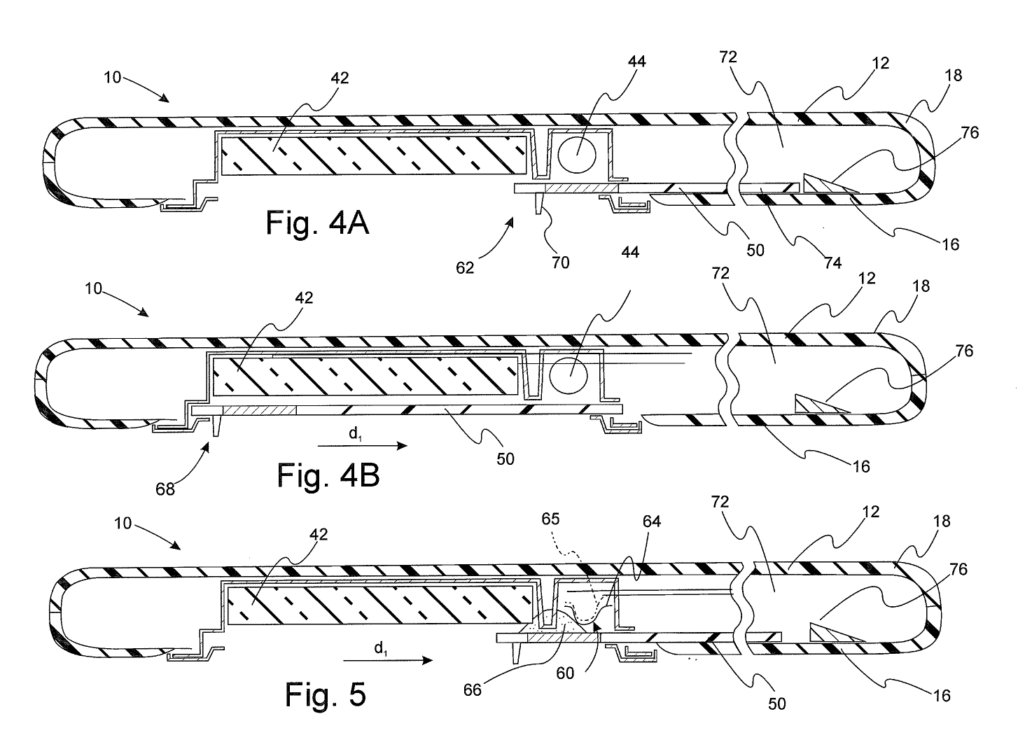

FIGS. 4A, 4B, 5 and 6 provide schematic cross sections illustrating the positioning and utilization of a contact switch to activate illumination source 44. FIG. 4A is a cross-section of sun visor 10 taken through illumination source 44 with moveable door 50 in the open position. FIG. 4B is a cross-section of sun visor 10 taken through illumination source 44 with moveable door 50 in the closed position. FIG. 5 is a cross-section of sun visor 10 taken through light subassembly 32 with moveable door 50 in a nearly closed position. FIG. 6 is a cross-section of sun visor 10 taken through illumination source but orthogonal to the sections of FIGS. 4A and 4B with moveable door 50 in a nearly closed position. Sun visor 10 includes contact switch 60 that activates illumination source 44 when door subassembly is positioned in open position 62. Door subassembly 34 optionally includes actuator 66 that engages contact switch 60 when door subassembly is in an open position 62 to initiate activation of illumination source 44. Position 64 provides the position of contact switch 60 in the open position while position 65 provides the position of contact switch 60 in the closed position. In a variation of the present embodiment, movable door 50 is slidable from open position 62 to closed position 68, and from the closed position 68 to the open position 62 along direction d₁. Moveable door 50 optionally includes handle 70 to allow a vehicle occupant to move moveable door 50 from the open to the closed position and visa versa. In this variation, first blade section 16 and second blade section 18 further define interior cavity 72 to receive portion 74 of door 50 when door subassembly 48 is in open position 62. Optional stops 76 are used to limit the motion of door subassembly 34.

With reference to FIGS. 1, 2 and 7 a sun visor with a vanity assembly having a vanity retainer is illustrated. FIG. 7 is a perspective view of vanity retainer 80. Advantageously, vanity retainer 80 attaches vanity assembly 14 to the visor blade assembly 12. In a further refinement, vanity retainer 80 includes one or more snap legs 82 that snap into snap receivers 26 located in visor blade assembly 12.

With reference to FIGS. 2, 8A, 8B and 8C, various techniques for accommodating the edge area of the vanity assembly positioned in the sun vane assembly is provided. FIG. 8A is a cross-section of a sun visor that uses a vanity bezel to hide the edge of vanity retainer 80. Sun visor 10 includes vanity bezel 90 which is positioned over edge 92 of vanity retainer 80. Vanity bezel 90 along with vanity retainer 80 also define channel 94 in which door 50 travels when moving from the closed position to the open position (and visa versa). FIG. 8B provides a cross-section of a sun visor with a similar configuration but also having an edge wrap opening construction. In this variation, sun visor 10 includes vanity bezel 90 which is positioned over edge 92 of vanity retainer 80, and edge wrap opening construction 98 which overlays vanity bezel 90. FIG. 8C provides a cross section of a sun visor configuration that uses an edge wrap opening construction but not a vanity bezel. In this variation, edge wrap opening construction 98 overlays at least a portion of vanity blade wall 100. Vanity blade wall 100 optionally includes one or more ribs 102 to hold vanity assembly 14 in place and to define channel 94. Ribs 102 typically run the entire length of vanity assembly 14.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A sun visor comprising:
a visor blade assembly, the visor blade having a first blade section and a second blade section, the first blade section attached to the second blade section thereby defining a vanity receptacle;
a vanity assembly attached to the vanity receptacle, the vanity assembly comprising:
a mirror subassembly having a mirror,
a light subassembly having an illumination source, and
a door subassembly reversibly movable from an open to a closed position relative to the mirror subassembly and the light subassembly, the door subassembly having a movable door and a light-transmitting component attached to the movable door, wherein when the door subassembly is positioned in the open position, the light transmitting component aligns with the illumination source such that light emanating from the illumination source is transmitted out of the light subassembly.

2. The sun visor of claim 1 wherein the light-transmitting component comprises a lens.

3. The sun visor of claim 2 wherein the lens comprises polycarbonate, acrylic, glass and combinations thereof.

4. The sun visor of claim 2 wherein the light-transmitting component comprises a convex or concave lens.

5. The sun visor of claim 2 wherein the light-transmitting component comprises a Fresnel lens.

6. The sun visor of claim 5 wherein the light-transmitting component comprises at least one substantially planer surface.

7. The sun visor of claim 1 further comprising a contact switch that activates the illumination source when the door subassembly is positioned in the open position.

8. The sun visor of claim 7 wherein the door subassembly further comprises an actuator that engages the contact switch when the door subassembly is in the open position to initiate activation of the illumination source.

9. The sun visor of claim 1 wherein the movable door is slidable from the open position to the closed position and from the closed to the open position.

10. The sun visor of claim 9 wherein the first blade section and a second blade section further define an interior cavity to receive at least a portion of the door when the door subassembly is in the open position.

11. The sun visor of claim 1 wherein the vanity assembly further comprises a vanity retainer that attaches the vanity assembly to the visor blade assembly.

12. The sun visor of claim 11 wherein the vanity retainer includes one or more snap legs that snap into receivers in the visor subassembly.

13. The sun visor of claim 1 wherein the door further comprises a handle to facilitate movement from the open to the closed positions.

14. A sun visor comprising:
a visor blade assembly, the visor blade having a first blade section and a second blade section, the first blade section attached to the second blade section thereby defining a vanity receptacle and an interior channel;
a vanity assembly attached to the vanity receptacle, the vanity assembly comprising:
a mirror subassembly having a mirror,
a light subassembly having an illumination source, and
a door subassembly slidable from an open to a closed position relative to the mirror subassembly and the light subassembly, the door subassembly having a door and a light-transmitting component attached to the movable door, wherein when the door subassembly is positioned in the open position the light transmitting component aligns with the illumination source such that light emanating from the illumination source is transmitted out of the light subassembly, and wherein at least a portion of the door is received into the interior channel.

15. The sun visor of claim 14 wherein the light-transmitting component comprises a lens.

16. The sun visor of claim 15 wherein the light-transmitting component comprises a Fresnel lens.

17. The sun visor of claim 1 further comprising a contact switch that activates the illumination source when the door subassembly is positioned in the open position.

18. The sun visor of claim 7 wherein the door subassembly further comprises an actuator that engages the contact switch when the door subassembly is in the open position to initiate activation of the illumination source.

19. A sun visor comprising:
a visor blade assembly, the visor blade having a first blade section and a second blade section, the first blade section attached to the second blade section thereby defining a vanity receptacle and an interior channel;
a vanity assembly attached to the vanity receptacle, the vanity assembly comprising:
a mirror subassembly having a mirror,
a light subassembly having an illumination source,
a door subassembly slidable from an open to a closed position relative to the mirror subassembly and the light subassembly, the door subassembly having a door and a Fresnel lens attached to the movable door, wherein when the door subassembly is positioned in the open position the light transmitting component aligns with the illumination source such that light emanating from the illumination source is transmitted out of the light subassembly, and wherein at least a portion of the door is received into the interior channel; and
a contact switch that activates the illumination source when the door subassembly is positioned in the open position.

20. The sun visor of claim 19 wherein the door subassembly further comprises an actuator that engages the contact switch when the door subassembly is in the open position to initiate activation of the illumination source.
